(19) United States
(12) Patent Application Publication
(10) Pub. No.: US 2019/0341599 A1
(43) Pub. Date: Nov. 7, 2019

(54) CATHODE ACTIVE MATERIAL, METHOD FOR PREPARING SAME, AND LITHIUM SECONDARY BATTERY COMPRISING SAME

(71) Applicants: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Sang Hyuk LEE, Incheon (KR); Sang Cheol NAM, Seoul (KR); Jung Hoon SONG, Seoul (KR)

(21) Appl. No.: 16/473,085

(22) PCT Filed: Dec. 20, 2017
(86) PCT No.: PCT/KR2017/015131

§ 371 Date: Jun. 24, 2019

(30) Foreign Application Priority Data
Dec. 22, 2016 (KR) 10-2016-0176977

(51) Int. Cl. H01M 4/131; H01M 4/525; H01M 4/134; H01M 10/0525; C01G 53/00

(52) U.S. Cl. CPC H01M 4/131; H01M 4/525; C01G 53/00; H01M 10/0525; H01M 4/134

(57) ABSTRACT

The present invention has been made in an effort to provide a preparation method of a positive electrode active material having improved structural stability and electrochemical characteristics by simultaneously coating Mn and B on the surface of a nickel-based lithium metal oxide, and to provide a lithium rechargeable battery including a positive electrode having a positive electrode active material that prepared by such a method.

### TECHNICAL FIELD

This specification relates to a positive active electrode material, a preparation method thereof, and a lithium rechargeable battery including the same.

### BACKGROUND ART

A positive electrode active material, which is one of elements constituting a lithium rechargeable battery, generally has a structure capable of releasing/inserting lithium ions. The positive electrode active material having a high manganese content shows high stability and low capacity. However, it is necessary to develop a positive electrode active material having excellent capacity and stability in order to realize the above-mentioned high-output large-sized battery type. On the other hand, the higher the nickel content of the positive electrode active material, the higher the capacity thereof. However, it is pointed out that the stability is low as compared with the positive material active material having a high manganese content, and the electrochemical capacity is reduced due to repeated charge and discharge, so that a cycle-life characteristic is poor. Specifically, in the case of the positive electrode active material containing nickel, an oxidation number of the nickel ion is changed from Ni²⁺ to Ni⁴⁺ after the lithium ion is removed, and since Ni⁴⁺ is unstable, it is chemically changed to nickel oxide (NiO). Since oxygen is generated during such a chemical change, the stability is evaluated to be low, and the nickel oxide is stable, and thus it may not exhibit its electrochemical capacity. In addition, since such a phenomenon is intensified at a higher temperature than at room temperature, there is a problem that the stability and the cycle-life characteristic at a high temperature are further deteriorated. In this regard, various researches have been carried out to improve the cycle-life characteristic while ensuring a high capacity of the lithium rechargeable battery, but a fundamental solution to the above problem has not yet been proposed.

### DISCLOSURE

### Description of the Drawings

The present invention has been made in an effort to provide a preparation method of a positive electrode active material having improved structural stability and electrochemical characteristics by simultaneously coating Mn and B on the surface of a nickel-based lithium metal oxide, and to provide a lithium rechargeable battery including a positive electrode having a positive electrode active material prepared by such a method.

An exemplary embodiment of the present invention provides a positive electrode active material for a lithium rechargeable battery, including lithium metal oxide particles having a nickel-based layered structure and a coating layer disposed on a surface of each of the lithium metal oxide particles.

Herein, the coating layer may be formed to include manganese (Mn), a manganese (Mn) compound, or a combination thereof; and boron (B), a boron (B) compound, or a combination thereof.

Specifically, the coating layer may include a mixture of a spinel phase and a rock salt phase.

More specifically, the spinel phase and the rock salt phase may be derived from the manganese (Mn) compound. In this case, the manganese (Mn) compound may include a lithium manganese oxide, a derivative thereof, a mixture thereof, or a combination thereof.

The coating layer may further include a hyaline amorphous phase which is vitreous, and may include a mixture of the spinel phase and the rock salt phase.

The vitreous hyaline amorphous phase may be derived from the boron (B) compound. In this case, the boron (B) compound may include lithium borate, a derivative thereof, a mixture thereof, or a combination thereof.

A weight ratio of [manganese (Mn), a manganese (Mn) compound, or a combination thereof] to [boron (B), a boron (B) compound, or a combination thereof] in the coating layer may be in a range of 1:1 to 1:10.

In a total amount of the cathode active material (100 wt %), the lithium metal oxide particles may be contained in an amount of 0.01 to 2 wt %, and the coating layer may be included as a balance.

In the meantime, the lithium metal oxide particles may have a concentration gradient of nickel. Specifically, the concentration gradient of nickel may have a form in which the concentration decreases from a center of the particle in a surface direction.

More specifically, the concentration gradient of nickel may exist from 50 to 95% by length of a particle radius from the center of the particle.

For the concentration gradient of nickel, the concentration may be decreased from the center of the particle in the surface direction until the particle has 40 mol % at 90% by length of the particle radius when the nickel concentration at the center of the particle is taken as 100 mol %.

The lithium metal oxide particle may have an average composition across the particle represented by Chemical Formula 1.

Li₁₊ₘ[Ni_{1-w1-x1-y1-z1}CO_{w1}M1ₓ₁M2_{y1}M3_{z1}]₁₊ₙO₂₋ₚ₁Xₚ₁ [Chemical Formula 1]

In Chemical Formula 1, M1 indicates any one element selected from a group consisting of Mn and Al. Each of M2 and M3 indicates any one element selected from a group consisting of Mg, Sn, Ca, Ge, and Ga, and X indicates any one element selected from a group consisting of F, N, and P. Each of w1, x1, y1, z1, and p4 may satisfy a following corresponding inequality: 0<w1≤0.2, 0≤x1≤0.1, 0≤y1≤0.1, 0<z1≤0.1, 0<w1+x1+y1+z1≤0.4, and 0≤p4≤0.1. m may satisfy an inequality: −0.05≤m≤0.25, and n may satisfy an inequality: −0.05≤n≤0.25.

Another exemplary embodiment of the present invention provides a preparation method of a positive electrode active material for a lithium rechargeable battery, including performing a heat treatment on a mixture of lithium metal oxide particles having a nickel-based layered structure, a Mn-supply material, and a B-supply material.

Specifically, the heat treatment may be performed in a temperature range of 150 to 400° C.

More specifically, the performing of the heat treatment may include heating at a temperature rise rate of 2 to 10° C./min until the temperature reaches the temperature range of 150 to 400° C.; and performing the heat treatment while maintaining the reached temperature range. In this case, the performing of the heat treatment while maintaining the reached temperature range may be performed for 2 to 10 hours.

In the meantime, the mixture may contain 0.01 to 1 parts by weight of the Mn-supply material and 0.01 to 2 parts by weight of the B-supply material for 100 parts by weight of the lithium metal oxide particle.

The Mn-supply material may be manganese carbonate (MnCO₃), manganese hydroxide (Mn(OH)₂), manganese oxide (MnO₂), or a combination thereof.

The B-supply material may be boric acid (H₃BO₃), anhydrous boric acid (B₂O₃), boron carbide (B₄C), or a combination thereof.

The method may further include preparing the lithium metal oxide particles before the performing of the heat treatment on the mixture. This may be done by a co-precipitation method. Specifically, particles with a concentration gradient of nickel may be prepared by using an aqueous solution of two kinds of metal salts having different molar concentrations of nickel.

Yet another exemplary embodiment of the present invention provides a lithium rechargeable battery including a positive electrode, a negative electrode, and an electrolyte solution, wherein the positive electrode includes the aforementioned positive electrode active material for the lithium rechargeable battery.

The cathode active material provided in the exemplary embodiment of the present invention is obtained by simultaneously coating Mn and B on the surface of the nickel-based lithium metal oxide particles, thereby increasing initial efficiency of the battery and minimizing a resistance increase rate during charging/discharging at a high temperature.

### BRIEF DESCRIPTION OF THE DRAWING

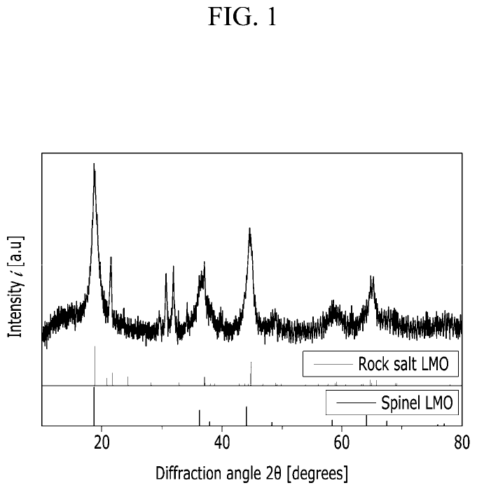

FIG. 1 illustrates a result of XRD observation of a powder obtained by heat-treating a mixture of LiOH.H₂O and MnCO₃.

### MODE FOR INVENTION

Hereinafter, exemplary embodiments of the present invention will be described in detail. However, it should be understood that the exemplary embodiments are merely examples, the present invention is not limited thereto, and the present invention is only defined by the scope of the following claims.

### Positive Electrode Active Material

An exemplary embodiment of the present invention provides a positive electrode active material for a lithium rechargeable battery, including lithium metal oxide particles having a nickel-based layered structure and a coating layer disposed on a surface of each of the lithium metal oxide particles.

Herein, the coating layer may include manganese (Mn), a manganese (Mn) compound, or a combination thereof; and boron (B), a boron (B) compound, or a combination thereof.

As mentioned above, the nickel-based lithium metal oxide has a problem in that it becomes structurally unstable as the content of nickel (Ni) increases.

However, the positive electrode active material provided in the exemplary embodiment of the present invention includes a lithium metal oxide particle of a nickel-based layered structure, and has improved structural stability and electrochemical characteristics through a coating layer disposed on the surface thereof.

Specifically, the boron (B), the boron (B) compound, or the combination thereof commonly includes the B element, and contributes to structural stabilization by suppressing side reactions with an electrolyte solution on the surface of the lithium metal oxide particle. For example, when the boron (B) compound contained in the coating layer is Li₂B₄O₇, the conductivity of the surface of the coating layer is further improved, so that the electrochemical characteristic of the battery can be improved.

However, as confirmed in evaluation examples to be described later, there is a limit in improving the structural stability and electrochemical characteristic because the boron (B) compound is dissolved by the electrolytic solution after the initial stage in the case of coating with only the boron (B).

Accordingly, the exemplary embodiment of the present invention proposes a coating layer further including the manganese (Mn), the manganese (Mn) compound, or the combination thereof in addition to the boron (B), the boron (B) compound, or the combination thereof.

The manganese (Mn), the manganese (Mn) compound, and the combination thereof commonly contain the Mn element, which forms a stable phase on the surface of the lithium metal oxide particle. For example, the manganese (Mn) compound contained in the coating layer may include a mixture of the spinel phase and the rock salt phase to improve the electrochemical characteristic.

As a result, in the case of simultaneous coating of B and Mn, residual lithium on the surface of the lithium metal oxide particle may be reduced, and at the time of application of the battery, the initial capacity and initial efficiency, the lifetime characteristic at a high temperature, and the like may be improved, and the resistance increase rate may be reduced.

Hereinafter, the positive electrode active material provided in the exemplary embodiment of the present invention will be described in detail.

The coating layer may include a mixture of the spinel phase and the rock salt phase.

More specifically, both the spinel phase and the rock salt phase may be derived from the manganese (Mn) compound. In this case, the manganese (Mn) compound may include a lithium manganese oxide, a derivative thereof, a mixture thereof, or a combination thereof.

The coating layer may further include a hyaline amorphous phase which is vitreous, and may include a mixture of the spinel phase and the rock salt phase.

The vitreous hyaline amorphous phase may be derived from the boron (B) compound. In this case, the boron (B) compound may include lithium borate, a derivative thereof, a mixture thereof, or a combination thereof.

Meanwhile, a weight ratio of [manganese (Mn), the manganese (Mn) compound, or a combination thereof] to [boron (B), the boron (B) compound, or a combination thereof] in the coating layer may be in a range of 1:1 to 1:10.

Within this range, an optimum effect may be accomplished such that residual lithium on the surface of the lithium metal oxide particle may be reduced, and at the time of application of the battery, the initial capacity and initial efficiency, the lifetime characteristic at a high temperature, and the like may be improved, and the resistance increase rate may be reduced.

In a total amount of the cathode active material (100 wt %), the lithium metal oxide particles may be contained in an amount of 0.01 to 2 wt %, and the coating layer may be included as a balance.

However, when the lithium metal oxide particles are contained in an amount exceeding the above range, a relatively small amount of the coating layer must be contained, and the effect expressed by the coating layer may be insignificant. On the other hand, when the lithium metal oxide particles are contained in a smaller amount than the range, basic capacity expression of the positive electrode active material may be poor.

The lithium metal oxide particles may have a concentration gradient of nickel. Specifically, the concentration gradient of nickel may have a form in which the concentration decreases from a center of the particle in a surface direction.

Specifically, the structure may be stabilized by increasing a molar content of nickel at the center of the lithium metal oxide particle to a high level to increase capacity, and by increasing a molar content of a dissimilar metal (e.g., Mn, Co, Al, or the like) while reducing the molar content of nickel in the surface direction.

More specifically, the concentration gradient of nickel may exist from 50 to 95% by length of a particle radius from the center of the particle. Further, for the concentration gradient of nickel, the concentration may be decreased from the center of the particle in the surface direction until the particle has 40 mol % at 90% by length of the particle radius when the nickel concentration at the center of the particle is taken as 100 mol %.

The lithium metal oxide particle may have an average composition across the particle represented by Chemical Formula 1.

L₁₊ₘ[Ni_{1-w1-x1-y1-z1}CO_{w1}M1ₓ₁M2_{y1}M3_{z1}]₁₊ₙO₂₋ₚ₁Xₚ₁ [Chemical Formula 1]

In Chemical Formula 1, M1 indicates any one element selected from a group consisting of Mn and Al. Each of M2 and M3 indicates any one element selected from a group consisting of Mg, Sn, Ca, Ge, and Ga, and X indicates any one element selected from a group consisting of F, N, and P. Each of w1, x1, y1, z1, and p4 may satisfy a following corresponding inequality: 0<w1≤0.2, 0≤x1≤0.1, 0≤y1≤0.1, 0<z1≤0.1, 0<w1+x1+y1+z1≤0.4, and 0≤p4≤0.1. m may satisfy an inequality of −≤0.05 m≤0.25, and n may satisfy an inequality of −0.05≤n≤0.25.

### Preparation Method of Positive Electrode Active Material

Another exemplary embodiment of the present invention provides a preparation method of a positive electrode active material for a lithium rechargeable battery, including performing a heat treatment on a mixture of lithium metal oxide particles having a nickel-based layered structure, a Mn-supply material, and a B-supply material.

This is one of the methods for obtaining the above-mentioned positive electrode active material, and simply includes performing a heat treatment on a mixture of lithium metal oxide particles having a nickel-based layered structure, a Mn-supply material, and a B-supply material.

Hereinafter, a description of the material finally obtained by the above method will be omitted, and a specific process characteristic of the above method will be described.

Specifically, the heat treatment may be performed in a temperature range of 150 to 400° C.

More specifically, the performing of the heat treatment may include heating at a temperature rise rate of 2 to 10° C./min until the temperature reaches the temperature range of 150 to 400° C., and performing the heat treatment while maintaining the reached temperature range. In this case, the performing of the heat treatment while maintaining the reached temperature range may be performed for 2 to 10 hours.

In this heat treatment condition, the Mn-supply material is converted to the manganese (Mn), the manganese (Mn) compound, or the combination thereof, and the B-supply material is converted to the boron (B), the boron (B) compound, or the combination thereof. Each converted form may be coated on the surface of the lithium metal oxide particle.

However, when the temperature is less than the reached temperature range, there is a problem in synthesis of the boron (B) compound and synthesis of the manganese (Mn) compound, and when the temperature exceeds the reached temperature range, there is a problem that residual lithium or the like (specifically, lithium hydroxide) increases. In addition, although the temperature is within the reached temperature range, when the time is shorter than the performance time range, there is a problem in synthesis of the boron (B) compound and synthesis of the manganese (Mn) compound, and when the time exceeds the performance time range, a process ratio is increased and strength of a positive electrode active material cake is increased. Therefore, it is necessary to satisfy the aforementioned conditions.

In the meantime, the mixture may contain 0.01 to 1 parts by weight of the Mn-supply material and 0.01 to 2 parts by weight of the B-supply material for 100 parts by weight of the lithium metal oxide particle. When they are controlled to satisfy the conditions, the content of the lithium metal oxide particle in the positive electrode active material and the weight ratio of [manganese (Mn), a manganese (Mn) compound, or a combination thereof] to [boron (B), a boron (B) compound, or a combination thereof] in the coating layer may be satisfied.

The Mn-supply material may be manganese carbonate (MnCO₃), manganese hydroxide (Mn(OH)₂), manganese oxide (MnO₂), or a combination thereof. It is not particularly limited as long as it is a material capable of supplying a Mn element.

The B-supply material may be boric acid (H₃BO₃), anhydrous boric acid (B₂O₃), boron carbide (B₄C), or a combination thereof. It is not particularly limited as long as it is a material capable of supplying a B element.

The method may further include preparing the lithium metal oxide particles before the performing of the heat treatment on the mixture. Specifically, particles with a concentration gradient of nickel may be prepared by using an aqueous solution of two kinds of metal salts having different molar concentrations of nickel.

More specifically, an aqueous solution of a first metal salt and an aqueous solution of a second metal salt having different molar concentrations of a nickel source material may be prepared, and particles having a concentration gradient of nickel may be prepared by the co-precipitation method.

For example, a step of forming the core portion by supplying the first metal salt aqueous solution to a reactor having a pH that is constantly maintained, to which a chelating agent is supplied at a constant rate, is referred to as a first co-precipitation step for convenience sake. After the first co-precipitation step, a shell portion may be continuously formed on a surface of the core portion by gradually decreasing a supply rate of the first metal salt aqueous solution and by gradually increasing a supply rate of the second metal salt aqueous solution. This step is referred to as a second co-precipitation step for convenience sake, and particles having a concentration gradient of nickel in the form of a core-shell may be obtained.

### Lithium Rechargeable Battery

An exemplary embodiment of the present invention provides a lithium rechargeable battery including: a positive electrode; a negative electrode; and an electrolyte.

This corresponds to a lithium rechargeable battery which exhibits excellent performance by including the above-described positive electrode active material, and the positive electrode active material has already been described in detail, so a detailed description will be omitted.

In addition, a configuration of a lithium rechargeable battery excluding the electrode positive active material is generally known.

Hereinafter, preferred examples of the present invention, comparative examples thereof, and evaluation examples thereof will be described. However, the following examples are only exemplary embodiments of the present invention, and the present invention is not limited to the following examples.

### Example 1 (Active Material:Manganese Carbonate:Boric Acid=100:0.12:0.15 (Weight Ratio), Heat Treatment at 250° C.)

### (1) Preparation of Positive Electrode Active Material

1) Preparation of Lithium Metal Oxide Particles

Lithium metal oxide particles having a concentration gradient of nickel were prepared.

Specifically, two metal salt aqueous solutions having different Ni, Co, and Mn concentrations were prepared by using NiSO4.6H2O as a nickel source material, CoSO4.7H2O as a cobalt source material, and MnSO4.H2O as a manganese source material.

A first metal salt aqueous solution for forming the core portion was prepared by mixing the source materials to satisfy a stoichiometric mole ratio of (Ni_{0.98}Co_{0.01}Mn_{0.01})(OH)₂ in distilled water such that an entire molar concentration of the metal salt reached 2.5 M.

Independently, a second metal salt aqueous solution for forming the shell portion was prepared by mixing the source materials to satisfy a stoichiometric mole ratio of (Ni_{0.7}Co_{0.2}Mn_{0.1})(OH)₂ in distilled water such that an entire molar concentration of the metal salt reached 2.5 M.

A co-precipitation reactor in which two metal salt aqueous solution supply tanks are connected in series was prepared, and the first metal salt aqueous solution and the second metal salt aqueous solution were charged into the respective metal salt aqueous solution supply tanks.

Three liters of distilled water was placed in the co-precipitation reactor (capacity of 20 L, output of a rotary motor of 200 W), nitrogen gas was supplied at a rate of 2 L/min to remove dissolved oxygen, and it was agitated at 140 rpm while maintaining a temperature of the reactor at 50° C.

In addition, NH₄(OH) of a 14 M concentration as a chelating agent and a NaOH solution of an 8 M concentration as a pH controlling agent were used, to continuously inject a solution mixed with NaOH:NH₄OH in a molar ratio of 1.9:1 to 2.2:1 into the reactor, while they were appropriately controlled to maintain a pH inside the reactor at 12 during the process.

As such, in a reactor having a pH that is constantly maintained, to which a chelating agent is supplied, a dosing time and amount of each metal salt solution were controlled from the two metal salt aqueous solution supply tanks connected in series.

Specifically, the co-precipitation reaction was performed until a diameter of the precipitate became about 16 μm by adjusting an impeller speed of the reactor to 500 rpm while injecting the first metal salt aqueous solution at 300 L/hour. In this case, an average residence time of the solution in the reactor was adjusted to about 24 hours by adjusting a flow rate, and a co-precipitation compound having a slightly higher density was obtained by giving a steady state duration to the reactant after the reaction reached the steady state.

Subsequently, a total supplied solution was injected at 350 L/hour by varying a mixing ratio of the first metal salt aqueous solution and the second metal salt aqueous solution, and after the lapse of 8 hours, the second metal salt aqueous solution was gradually increased as the first metal salt aqueous solution at a supply rate of 160 L/hour. In this case, the average residence time of the solution in the reactor was adjusted to 24 hours or less by controlling the flow rate, and finally the co-precipitation reaction was performed until the diameter of the precipitate became 16 μm.

Accordingly, finally obtained precipitates were lithium metal oxide particles having an average composition of Li(Ni_{0.88}Co_{0.09}Mn_{0.03})O₂ and a concentration gradient of nickel.

Specifically, when the nickel concentration at the center of the particle is taken as 100 mol %, it gradually decreases in the surface direction, and the nickel concentration at 90% by length of the whole particle radius is 40 mol %.

The lithium metal oxide particles obtained as the precipitates were washed with water and dried. Specifically, 100 g of the lithium metal oxide particles were taken in 100 g of distilled DI water and agitated for 10 minutes to prepare a slurry, which was then filtered and dried in a vacuum drier at 100° C. for 12 hours.

2) Coating of Surfaces of Lithium Metal Oxide Particles

In a mixer, for 100 g of the washed and dried lithium metal oxide particles, 0.15 g of boric acid (H₃BO₃) and 0.12 g of manganese carbonate (MnCO₃) were agitated for 1 minute and mixed.

The mixture was charged into a sintering furnace, heated at a rate of 3° C./min, and heat treated at 250° C. for 5 hours.

### (2) Preparation of Lithium Rechargeable Battery.

The positive electrode active material prepared in the above, a conductive material (Denka black, carbon-based conductive material), and a binder (PVDF) were uniformly mixed in an N-methyl-2-pyrrolidone solvent at a weight ratio of 96:2:2 (description order: positive electrode active material:conductive material:binder), to prepare a slurry.

The slurry was evenly applied to an aluminum foil, compressed by a roll press, and vacuum dried in a vacuum oven at 100° C. for 12 hours to form a positive electrode.

Li-metal was used as a counter electrode, and 2032 half coin cells were formed according to a conventional manufacturing method using 1 mole of a LiPF₆ solution as a liquid electrolyte in a mixed solvent of EC:EMC=1:2.

### Example 2 (Active Material:Manganese Carbonate:Boric Acid=100:0.24:0.15 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:0.24:0.15, to form 2032 coin cells.

### Example 3 (Active Material:Manganese Carbonate:Boric Acid=100:0.36:0.15 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:0.36:0.15, to form 2032 coin cells.

### Example 4 (Active Material:Manganese Carbonate:Boric Acid=100:0.48:0.15 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:0.48:0.15, to form 2032 coin cells.

### Example 5 (Active Material:Manganese Carbonate:Boric Acid=100:0.48:0.15 (Weight Ratio), Heat Treatment at 300° C.)

A positive electrode active material was prepared in the same manner as in Example 1 except that the weight ratio of active material:manganese carbonate:boric acid=100:0.12:0.15 was changed to a weight ratio of 100:0.48:0.15, and the heat treatment temperature was changed from 250° C. to 300° C., to form 2032 coin cells.

### Example 6 (Active Material:Manganese Carbonate:Boric Acid=100:0.12:0.26 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:012:0.26.

### Example 7 (Active Material:Manganese Carbonate:Boric Acid=100:0.36:0.26 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:036:0.26.

### Example 8 (Active Material:Manganese Carbonate:Boric Acid=100:0.12:0.32 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of 100:012:0.32.

### Example 9 (Active Material:Manganese Carbonate:Boric Acid=100:0.12:0.32 (Weight Ratio), Heat Treatment at 300° C.)

A positive electrode active material was prepared in the same manner as in Example 1 except that the weight ratio of active material:manganese carbonate:boric acid=100:0.12:0.15 was changed to a weight ratio of 100:012:0.32, and the heat treatment temperature was changed from 250° C. to 300° C., to form 2032 coin cells.

### Comparative Example 1

The washed and dried lithium metal oxide particles obtained in the pre-coating step of Example 1 were used as a positive electrode active material. A 2032 coin battery was formed by using the positive electrode active material in the same manner as in Example 1.

### Comparative Example 2 (Active Material:Boric Acid=100:0.15 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:boric acid=100:0.15 excluding manganese carbonate, to form 2032 coin cells.

### Comparative Example 3 (Active Material:Boric Acid=100:0.26 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:boric acid=100:0.26 excluding manganese carbonate, to form 2032 coin cells.

### Comparative Example 4 (Active Material:Boric Acid=100:0.32 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:boric acid=100:0.32 excluding manganese carbonate, to form 2032 coin cells.

### Comparative Example 5 (Active Material:Manganese Carbonate=100:0.12 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:manganese carbonate=100:0.12 excluding boric acid, to form 2032 coin cells.

### Comparative Example 6 (Active Material:Manganese Carbonate=100:0.24 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:manganese carbonate=100:0.24 excluding boric acid, to form 2032 coin cells.

### Comparative Example 7 (Active Material:Manganese Carbonate=100:0.36 (Weight Ratio), Heat Treatment at 250° C.)

A positive electrode active material was prepared in the same manner as in Example 1 except that the weight ratio of active material:manganese carbonate:boric acid=100:0.12:0.15 was changed to a weight ratio of active material:manganese carbonate=100:0.36 excluding boric acid, to form 2032 coin cells.

### Evaluation Example 1

Lithium remaining on the surfaces of the respective positive electrode active materials of Examples 1 to 8 and Comparative Examples 1 to 4 was measured and is recorded in Table 1.

Initial efficiency, high-temperature cycle-life, and increase characteristic in high-temperature resistance for each battery were evaluated and are recorded in Table 1. The specific evaluation conditions are as follows.
Reference capacity: 200 mAh/g
Initial capacity evaluation: 0.2 C charge/0.2 C discharge after 10 hours OCV measurement
Evaluation of high-temperature cycle-life characteristics: a charge-discharge cycle was performed 30 times under a condition of 0.3 C charge/0.3 C discharge at a high temperature (45° C.) and a potential range 4.25 V to 2.5 V.
High-temperature DC-iR evaluation: the charge/discharge cycle was carried out at a high temperature (45° C.), and the voltage was measured 60 seconds after applying a discharge current of 0.3 C at 100% of 4.25 V.

TABLE 1

| | | | | High | High | Room |
|---|---|---|---|---|---|---|
| | | Initial | Initial | temperature | temperature | temperature |
| | Residual | capacity | efficiency | cycle-life | resistance | initial |
| | lithium | (@ 0.2 C) | (%) | (Capacity | increase rate | resistance |
| | (Li₂CO₃/LiOH) | (mAh/g) | (%) | retention, %) | (%) | (Ω) |
| Comparative Example 1 | 2,258/2,813 | 211.5 | 90.4 | 85.5 | 238.5 | 19.5 |
| Comparative Example 2 | 2,519/1,929 | 216.1 | 91.9 | 94.7 | 228.2 | 23.2 |
| Comparative Example 3 | 2,455/2,680 | 215.6 | 91.8 | 95.9 | 174.5 | 25.9 |
| Comparative Example 4 | 1,988/2,970 | 215.4 | 91.3 | 95.2 | 128.3 | 27.8 |
| Comparative Example 5 | 2,032/2,421 | 211.6 | 90.5 | 85.6 | 236.2 | 21.7 |
| Comparative Example 6 | 2,124/2,256 | 211.4 | 90.6 | 86.5 | 220.5 | 23.9 |
| Comparative Example 7 | 1,815/2,358 | 211.7 | 90.3 | 87.0 | 204.8 | 26.5 |
| Example 1 | 2,245/1,913 | 214.0 | 91.5 | 95.5 | 187.6 | 20.2 |
| Example 2 | 2,312/1,881 | 214.7 | 91.9 | 95.0 | 210.3 | 22.2 |
| Example 3 | 2,196/1,986 | 216.1 | 92.2 | 95.0 | 233.5 | 23.8 |
| Example 4 | 2,388/1,986 | 215.3 | 91.9 | 94.9 | 217.4 | 24.2 |
| Example 5 | 2,771/1,866 | 212.7 | 90.7 | 93.8 | 233.5 | 23.4 |
| Example 6 | 2,163/2,604 | 215.6 | 92.1 | 96.2 | 134.8 | 21.2 |
| Example 7 | 2,544/2,669 | 217.0 | 92.4 | 95.5 | 164.7 | 24.8 |
| Example 8 | 2,474/2,988 | 213.3 | 91.3 | 95.1 | 159.7 | 24.2 |
| Example 9 | 2,065/2,835 | 215.3 | 91.7 | 95.9 | 136.0 | 22.8 |

In Table 1, referring to Comparative Examples 1 to 4, as the B content of the coating layer is increased, the residual lithium tends to increase, and when the coating is excessively performed, the initial capacity tends to decrease. In addition, the high-temperature cycle-life tends to be excellent, the increase rate in the high-temperature resistance is reduced, and the initial resistance at room temperature rapidly increases.

Referring to Comparative Examples 4 to 7, as the Mn content of the coating layer increases, the initial resistance at room temperature tends to increase, and the initial capacity does not differ. In addition, it can be confirmed that the high-temperature cycle-life becomes excellent, the increase rate in the high-temperature resistance is reduced, and the initial resistance at room temperature increases.

In contrast to Comparative Examples 2 to 7, Examples 1 to 9 show that all aspects of the residual lithium, the initial capacity, the initial efficiency, the high temperature cycle-life, the increase characteristic in high-temperature resistance, and the initial resistance at room temperature are advantageous. This is due to coating with Mn together with B.

Specifically, also referring to Examples 1 to 9, the initial resistance increases as the Mn content increases, and the increase rate in the high-temperature resistance tends to increase. Referring to Example 1 to 9, as in Comparative Example 1 to 4, as the B content increases, the high temperature characteristic becomes excellent and the initial capacity decreases. However, the relationship between Mn and B does not have a significant effect, but when the content of B is excessive, addition of Mn causes the coating layer to become thicker and deteriorate in properties.

In addition, referring to results of Comparative Examples 1 to 4 and Examples 1 to 9, when a small amount of Mn is added to the same B content, the initial resistance is remarkably lowered, and it shows a better characteristic than coating Mn or B alone.

### Evaluation Example 2 (XRD)

Specifically, in Examples 1 to 8, a powder obtained by heat-treating a mixture of LiOH.H₂O and MnCO₃ as a lithium compound was determined as a target to be evaluated in order to check a phase of the coating layer formed on the surface of the lithium metal oxide particles during the heat treatment of manganese carbonate.

Specifically, the mixture was made at a mole ratio of LiOH.H₂O:MnCO₃=1:2, and the temperature was increased to 250° C. at 5° C./min to be maintained for 5 hours, and then was decreased to obtain the powder, which was subjected to XRD analysis under conditions of 45 kV, 40 mA, CS 40 s/scan, and S/S: 0.02 rad to obtain an XRD graph of a 28 range of 10 to 80° (equipment name: X'pert3) (see FIG. 1).

Referring to FIG. 1, it can be seen that when manganese carbonate is mixed with a lithium compound and subjected to a heat treatment, lithium manganese oxide of a spinel phase and lithium manganese oxide of a rock salt phase are mixed.

From the results of FIG. 1, in Examples 1 to 8, it is deduced that manganese carbonate partially reacted on the surface of the lithium metal oxide particles, which are a kind of lithium compound, and thus a coating layer including a mixture of lithium manganese oxide of the spinel phase and lithium manganese oxide of the rock salt phase is formed.

Further, B partially reacts on the surface of the lithium metal oxide particles, which are a kind of lithium compound, to form Li₂B₄O₇. Li₂B₄O₇ forms a hyaline amorphous phase, which is amorphous and therefore cannot be confirmed by XRD, but in the Evaluation Example 1, since the cell performance is improved as the B content is increased, the presence thereof can be indirectly confirmed.

The present invention may be embodied in many different forms, and should not be construed as being limited to the disclosed embodiments. In addition, it will be understood by those skilled in the art that various changes in form and details may be made thereto without departing from the technical spirit and essential features of the present invention. Therefore, it is to be understood that the above-described exemplary embodiments are for illustrative purposes only and the scope of the present invention is not limited thereto.

1. A positive electrode active material for a lithium rechargeable battery, the material comprising:
a lithium metal oxide particle of a nickel-based layered structure; and
a coating layer disposed on a surface of the lithium metal oxide particle,
wherein the coating layer includes:
manganese (Mn), a manganese (Mn) compound, or a combination thereof; and
boron (B), a boron (B) compound, or a combination thereof.

2. The positive electrode active material of claim 1,
wherein the coating layer includes
a mixture of a spinel phase and a rock salt phase.

3. The positive electrode active material of claim 2, wherein
the spinel phase and the rock salt phase
are derived from the manganese (Mn) compound.

4. The positive electrode active material of claim 3, wherein
the manganese (Mn) compound includes
a lithium manganese oxide, a derivative thereof, a mixture thereof, or a combination thereof.

5. The positive electrode active material of claim 2,
wherein the coating layer
further includes a vitreous hyaline amorphous phase,
including a mixture of the spinel phase and the rock salt phase,
wherein the vitreous hyaline amorphous phase is derived from the boron (B) compound.

6. (canceled)

7. The positive electrode active material of claim 5, wherein
the boron (B) compound includes
a lithium borate, a derivative thereof, a mixture thereof, or a combination thereof.

8. The positive electrode active material of claim 1, wherein
a weight ratio of [manganese (Mn), a manganese (Mn) compound, or a combination thereof] to [boron (B), a boron (B) compound, or a combination thereof] in the coating layer is in a range of 1:1 to 1:10.

9. The positive electrode active material of claim 1, wherein
in a total amount of the positive electrode active material (100 wt %),
the lithium metal oxide particle is contained in an amount of 0.01 to 2 wt %, and the coating layer is included as a balance.

10. The positive electrode active material of claim 1, wherein
the nickel-based lithium metal oxide particle
has a concentration gradient of nickel,
wherein the concentration gradient of nickel has a form in which the concentration decreases from a center of the particle in a surface direction.

11. (canceled)

12. The positive electrode active material of claim 9, wherein
the concentration gradient of nickel
exists from 50 to 95% by length of a particle radius from the center of the particle.

13. The positive electrode active material of claim 12, wherein
the concentration gradient of nickel
has a form in which the concentration is decreased from the center of the particle in the surface direction until the particle has 40 mol % at 90% by length of the particle radius when the nickel concentration at the center of the particle is taken as 100 mol %.

14. The positive electrode active material of claim 13, wherein
the nickel-based lithium metal oxide particle
has an average composition across the particle represented by Chemical Formula 1:
Li₁₊ₘ[Ni_{1-w1-x1-y1-z1}Co_{w1}M1ₓ₁M2_{y1}M3_{z1}]₁₊ₙO₂₋ₚ₁Xₚ₁ [Chemical Formula 1]
wherein, in Chemical Formula 1,
M1 indicates any one element selected from a group consisting of Mn and Al,
each of M2 and M3 indicates an element selected from a group consisting of Mg, Sn, Ca, Ge, and Ga,
X is one element selected from the group consisting of F, N, and P, and
each of w1, x1, y1, z1, and p1 satisfies a following corresponding inequality: 0<w1≤0.2, 0≤x1≤0.1, 0≤y1≤0.1, 0≤z1≤0.1, 0<w1+x1+y1+z1≤0.4, and 0≤p1≤0.1,
m may satisfy an inequality: −0.05≤m≤0.25, and
n may satisfy an inequality: −0.05≤n≤0.25.

15. A preparation method of a positive electrode active material for a lithium rechargeable battery, the method comprising
performing a heat treatment on a mixture of lithium metal oxide particles having a nickel-based layered structure, a Mn-supply material, and a B-supply material,
wherein the heat treatment is performed in a temperature range of 150 to 400° C.

16. (canceled)

17. The preparation method of claim 15, wherein
the heat treatment includes:
heating at a temperature rise rate of 2 to 10° C./min until the temperature reaches the temperature range of 150 to 400° C.; and
performing the heat treatment while maintaining the reached temperature range.

18. The preparation method of claim 17, wherein
the performing of the heat treatment while maintaining the reached temperature range
is performed for 2 to 10 hours.

19. The preparation method of claim 15, wherein
the mixture
contains 0.01 to 1 parts by weight of the Mn-supply material and 0.01 to 2 parts by weight of the B-supply material for 100 parts by weight of the lithium metal oxide particle.

20. The preparation method of claim 15, further comprising
preparing the lithium metal oxide particles before the performing of the heat treatment on the mixture.

21. The preparation method of claim 20, wherein
the preparation of the lithium metal oxide particle
is done by a co-precipitation method.

22. The preparation method of claim 21, wherein
in the preparation of the lithium metal oxide particle,
particles with a concentration gradient of nickel are prepared by using an aqueous solution of two kinds of metal salts having different molar concentrations of nickel.

23. A lithium rechargeable battery, comprising:
a positive electrode;
a negative electrode; and
an electrolyte,
wherein the positive electrode includes the positive electrode active material for a lithium rechargeable battery according to claim 1.
